(19) United States
(12) Patent Application Publication
(10) Pub. No.: US 2008/0237415 A1
(43) Pub. Date: Oct. 2, 2008

(54) HOIST APPARATUS

(76) Inventor: John Michalec, Boerne, TX (US)

Correspondence Address: WOOD AND EISENBERG, PLLC, 6911 RICHMOND HIGHWAY, SUITE 403, Alexandria, VA, 22306, US

(21) Appl. No.: 11/750,338

(22) Filed: May 18, 2007

Related U.S. Application Data
(60) Provisional application No. 60/908,407, filed on Mar. 28, 2007.

(51) Int. Cl. F16M 11/26; B66D 1/00; F16M 11/02

(52) U.S. Cl. 248/157; 254/264; 254/266

(57) ABSTRACT

A hoist apparatus. The hoist apparatus includes a head plate having a top and bottom surface; a pulley system attached to the top surface of the head plate; a first sleeve, a second sleeve and a third sleeve; a plurality of legs comprising a first leg, a second leg and a third leg, whereupon assembly of the hoist apparatus the legs form a tripod; a winch; and a flexible line. The winch is attached to one of the legs such that upon assembly of the hoist apparatus, the winch points outwards from the tripod and is aligned with the pulley system. In one embodiment of the invention, the head plate, pulley system, and the sleeves are integrated to provide a single integral top section. In another embodiment, the hoist apparatus is provided in kit form and includes a top section, legs, winch, and line.

### CROSS-REFERENCE TO RELATED APPLICATIONS

This application claims the benefit of priority from U.S. Provisional Patent Application Ser. No. 60/908,407, filed Mar. 28 2007, the entire contents of which are incorporated herein by reference.

### STATEMENT REGARDING FEDERALLY SPONSORED RESEARCH OR DEVELOPMENT

Not Applicable.

### FIELD OF THE INVENTION

The present invention relates to devices for hoisting items of interest to game hunters.

### BACKGROUND OF THE INVENTION

Hunters, such as deer hunters, have a limited time to enjoy their passion for hunting game. Thus, there is a need for devices and ways to render the sport of hunting more efficient without detracting from the spirit of hunting game.

U.S. Pat. No. 4,997,152, issued Mar. 5, 1991 to Wagman et al., describes a hoist-type support for use by hunters to support game objects and including a top head having circumferentially-spaced notches in excess of two and each notch pivotally receiving the upper end of a leg in a manner to limit the outward movement of the leg beyond a maximum angle of 70° to the horizontal plane of the top head. A block and tackle unit having two blocks with the tackle extending therebetween, one of said blocks being connected to and depending from the top head and also having one end of the tackle fixed thereto with the other block having means to which game objects are connected for support thereby and the block and tackle unit also having a locking member which is operable automatically to prevent lowering of the other block after a game object has been connected thereto and elevated to a desired position.

U.S. Patent Publication No. 20050034921, published Feb. 17, 2005, 1993 to Griffiths, describes an elevated platform configurable for use in cooperation with a tree or pole, or as a free-standing unit. A triangular assembled configuration provides maximum safety and rigidity with a minimum complexity and weight. Interchangeable components, universal connectors, and tool-free assembly result in ease and speed for assembly and disassembly. The platform is adaptable for use in any number of configurations and is transformable into a trailer for towing by a person, ATV, or vehicle. Additionally, a gun/camera rail, bow rack, weather resistant shelter, and a swivel seat provide improved comfort for extended use.

U.S. Pat. No. 7,059,956, issued Jun. 13, 2006 to Summerlin, describes a device for hoisting and skinning large game in the wilderness. A pair of upright members extend upward from base members, and a cross beam joins upper ends of the upright members to form a rigid frame. A winch mounted on an upright member includes a barrel sufficiently wide to accommodate two cables in side-by side relation and a handle for rotating the barrel. A first cable extends from the barrel of the winch through a dual-sheaved pulley suspended from the cross beam proximal to the winch and thence through a second pulley suspended from the cross beam distal to the winch. A second cable extends from the barrel of the winch through the dual-sheaved pulley. With the hind legs of a carcass attached to the cables, rotating the handle hoists the carcass and tensions apart the hind legs to facilitate skinning. In an alternative embodiment, the frame comprises three upright members pivotally attached to a cross beam and capable of being positioned on a ground surface in tripod configuration.

None of the above inventions and patents, taken either singly or in combination, is seen to describe the instant invention as claimed.

### SUMMARY OF THE INVENTION

A hoist apparatus. The hoist apparatus includes a head plate having a top and bottom surface; a pulley system attached to the top surface of the head plate; a first sleeve, a second sleeve and a third sleeve; a plurality of legs comprising a first leg, a second leg and a third leg, whereupon assembly of the hoist apparatus the legs form a tripod; a winch; and a flexible line. The winch is attached to one of the legs such that upon assembly of the hoist apparatus, the winch points outwards from the tripod and is aligned with the pulley system. In one embodiment of the invention, the head plate, pulley system, and the sleeves are integrated to provide a single integral top section. In another embodiment, the hoist apparatus is provided in kit form and includes a top section, legs, winch, and line.

### BRIEF DESCRIPTION OF THE DRAWINGS

FIG. 1 shows a perspective view of a hoist apparatus according to the present invention.

FIG. 2 shows a perspective view of the hoist apparatus of FIG. 1, but shown holding a load.

FIG. 3 shows a further perspective view of the top of the hoist apparatus of FIG. 1, but shown in close view.

FIG. 4 shows a perspective view of an example winch attached to a leg according to the present invention.

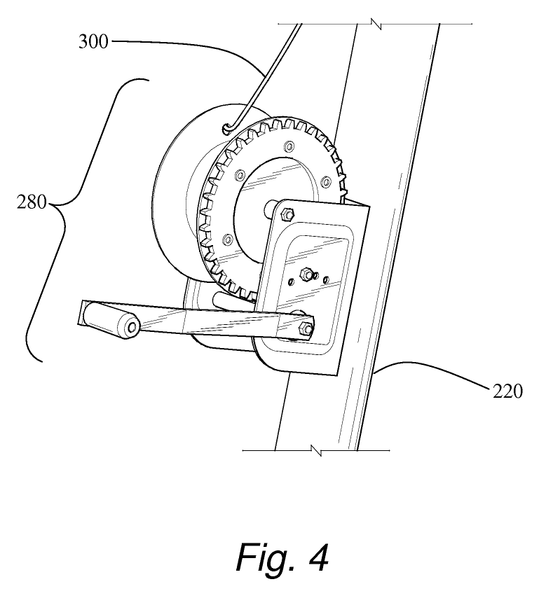

FIG. 5 shows a perspective view of a hoist apparatus according to the present invention.

FIGS. 6 and 7 respectively show top and bottom views of a single integral top section according to the present invention.

FIG. 8 shows a side view of the single integral top section shown in FIGS. 6 and 7.

FIG. 9 shows a kit version of a hoist apparatus according to the present invention.

FIG. 10 shows a perspective view of the top of a hoist apparatus according to the present invention.

FIG. 11 shows a kit version of a hoist apparatus according to the present invention.

Similar reference characters denote corresponding features consistently throughout the attached drawings.

### DETAILED DESCRIPTION OF THE INVENTION

The present invention is directed to a hoist apparatus having a winch attached to a tripod leg for hoisting items such as, but not limited to, game feed or game feeding devices. The hoist apparatus of the present invention is denoted generally by the numeric label “100”.

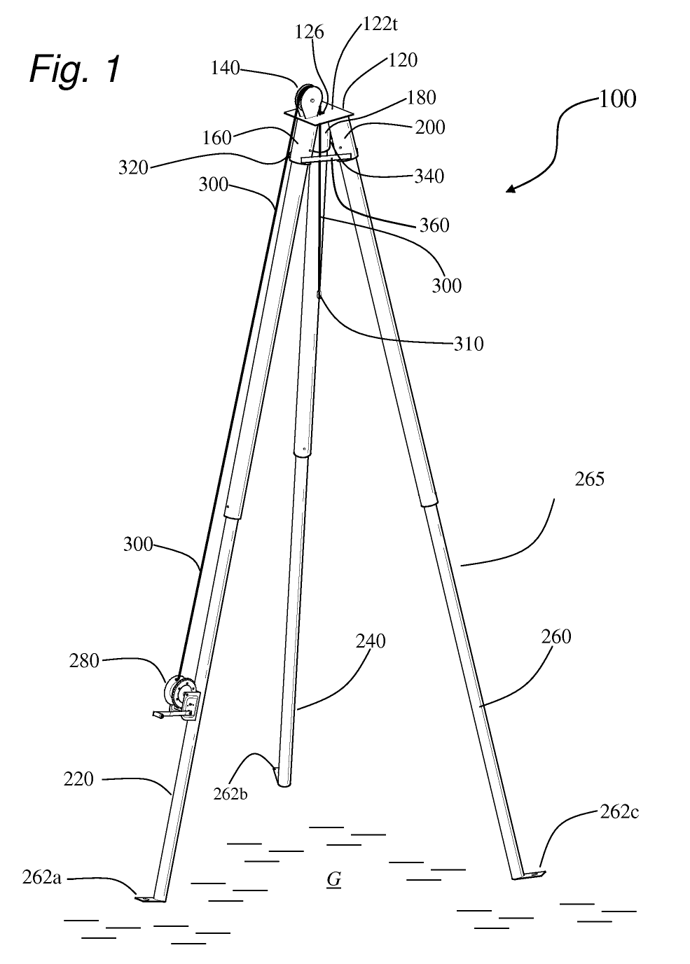

Referring to the Figures in general, the hoist apparatus 100 is erected on any suitable ground G. The hoist apparatus 100 includes a head plate 120; a pulley system 140; a first sleeve 160, a second sleeve 180 and a third sleeve 200; a plurality of legs comprising a first leg 220, a second leg 240 and a third leg 260; a winch 280; and a flexible line 300. The hoist apparatus 100 can further comprise optional reinforcing bars; specifically, a first reinforcing bar 320, a second reinforcing bar 340, and a third reinforcing bar 360. The optional first 320, second 340 and third 360 reinforcing bars are each of generally elongated appearance and respectively extend between the first 160 and second 180 sleeves, the second 180 and third 200 sleeves, and the third 200 and first 180 sleeves. Any suitable hook or attachment device to facilitate attaching loads to the line 300 can be provided, such as a hook 310 (see, e.g., FIGS. 1, 2 and 9).

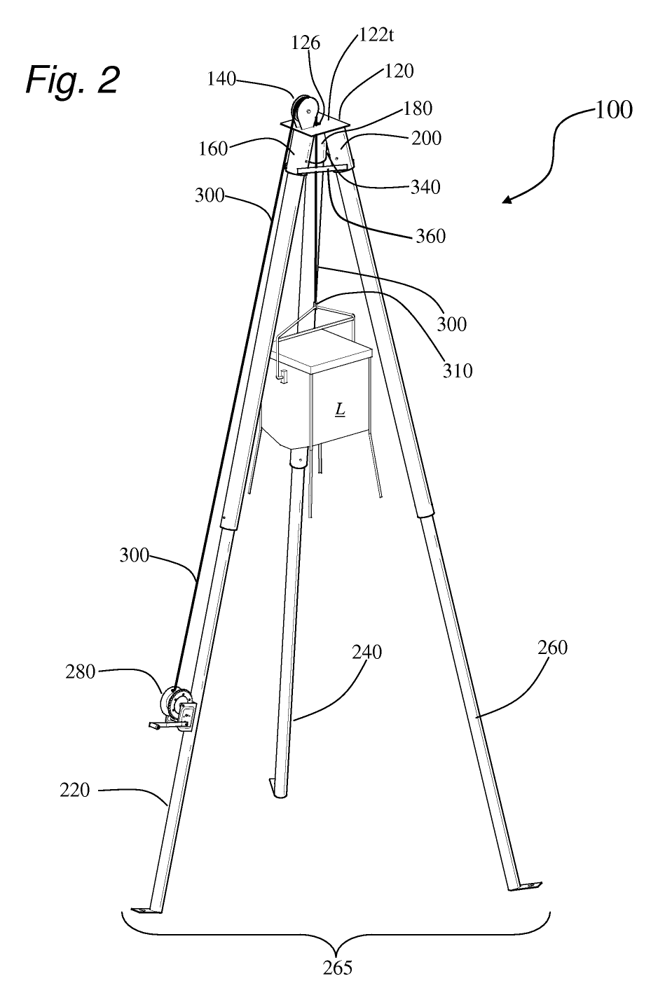

During normal operation of an assembled hoist 100, the flexible line 300 is controllably played out from the winch 280. The line 300 extends from the winch 280 to the pulley system 140, and in particular pulley 142, and thence through the through-orifice 126 in the head plate 120 to dangle below the head plate 120 and by means of the winch 280 is used for hoisting a load L (see FIG. 2).

Still referring to the Figures in general, the head plate 120 is of generally planar appearance and defines a top surface 122t, a bottom surface 122b, and a through-orifice 126. The pulley system 140 is mounted on the top surface 122t of the head plate 120 and at a perpendicular angle with respect to the top surface 122t. Each of said first 160, second 180 and third 200 sleeves are each attached to the bottom surface 122b of said head plate 120 and extend 15 at a divergent angle away from the bottom surface 122b (see, e.g., FIG. 7). Each of the sleeves 160, 180 and 200 include a hollow bore HB; more specifically, each sleeve is dimensioned to accommodate a leg. In assembling the hoist apparatus 100, legs 220, 240 and 260, one end of each leg is fitted into the sleeves 160, 180, and 200. Once fitted into the sleeves 160, 180 and 200, the legs 220, 240 and 260 form a tripod 265. Any suitable method or device can be used to secure the legs to the sleeves such as a through-securing bolt 270 fitted through appropriately located and aligned apertures in the sleeves and one end of each leg. Leg feet 262a, 262b and 262c can be fitted to one end of legs 220, 240 and 260 to provide grip when the tripod 265 is placed on the ground G.

In one embodiment, any of the legs 220, 240 and 260 can fit to any of the sleeves 160, 180 and 200. The only important consideration is that the winch 280 is fitted to the leg that is in vertical alignment with the pulley system 140.

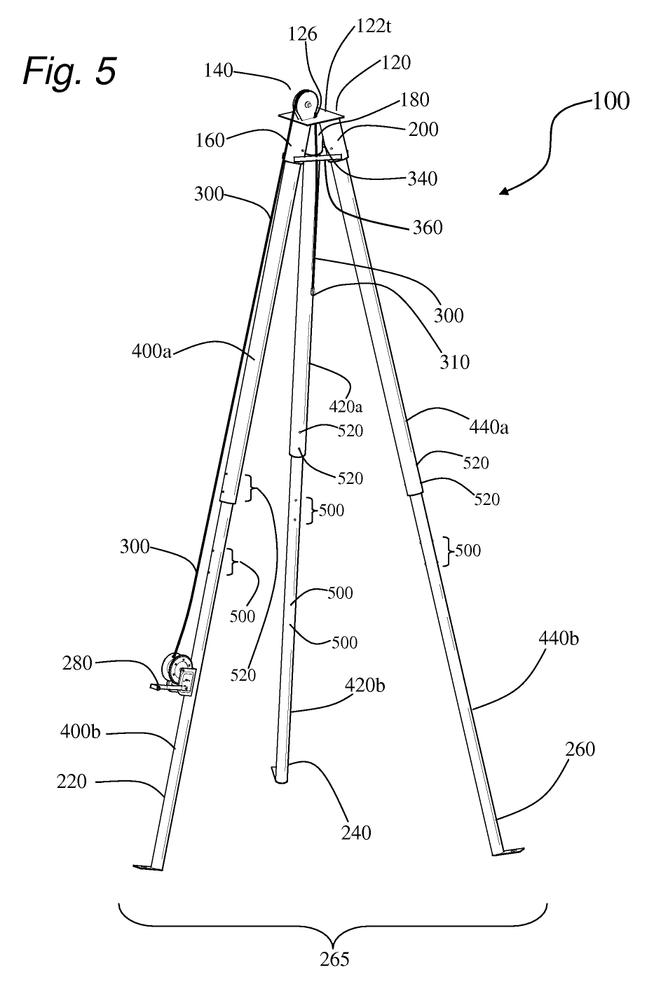

In one embodiment, the first, second and third legs 220, 240 and 260 optionally comprise a plurality of hollow tubes with progressively increasing diameters, so that the legs can be selectively adjusted to a predetermined height thereby making the first, second and third legs are selectively height adjustable, i.e., the legs 220, 240 and 260 can be manufactured or otherwise provided as telescopic legs. For example, first leg 220 can comprise tubes 400a and 400b, second leg 240 tubes 420a and 420b, and third leg 260 can comprise tubes 440a and 440b (see FIG. 5). The mechanism of operation of telescopic type legs is described, for example, in U.S. Publication Number 20040135879, published Jul. 15, 2004 to Marco et al. The Marco '879 is incorporated herein by reference in its entirety; likewise with respect to all other U.S. issued patents or U.S. published patent applications cited anywhere in this disclosure, which are all incorporated herein in by reference in their entirety.

Height locking bolts (see FIG. 5) can be used to lock the height of the legs to a selected height; apertures 500 can be drilled or otherwise provided in the tube sections that make up the legs for fitting the height locking bolts 520. The hollow tubes that make up the legs can be made of tubes of high strength but lightweight metal, such as aluminum with a circular cross sectional area. While circular cross section tubes are preferred, any suitable configuration may be used, e.g., the tubes (and the legs in general) may comprise of hollow square or hollow rectangular steel tube sections. Alternatively, the tube sections (and legs in general) may be made of a plastic or fiber glass to ensure lightness and resistance to weathering.

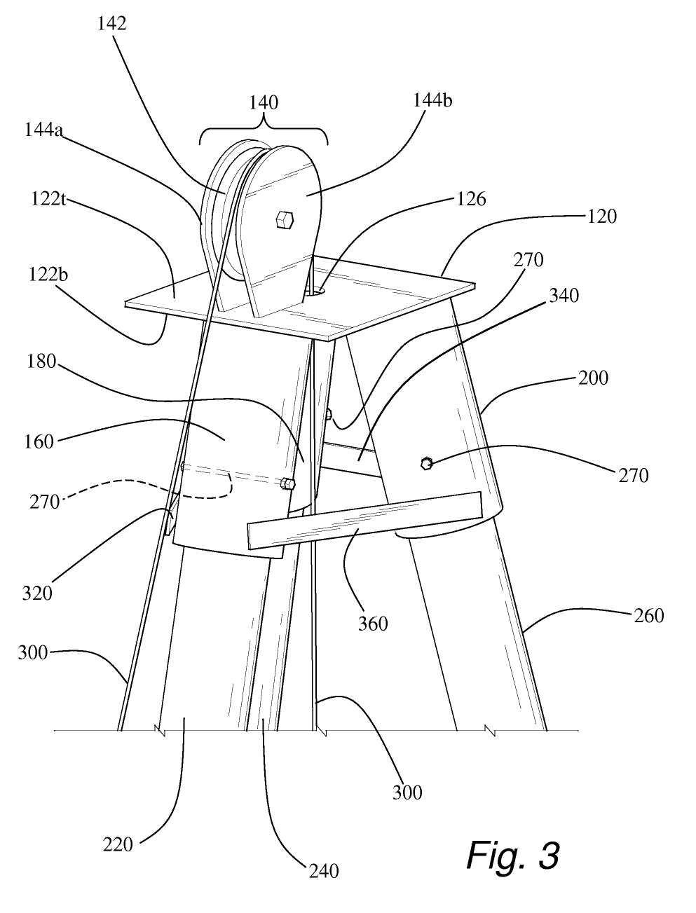

The winch 280 is fitted to one of the legs 220, 240 and 260 such that upon assembly of the hoist apparatus 100, the winch 280 points outwards from the tripod 265 and is aligned with the pulley system 140. The pulley system 140 comprises a free-running pulley 142. The pulley 142 is supported by, and mounted between, first and second support members 144a and 144b (see FIG. 3). It should be understood that the winch 280 can be fitted to any leg so long as upon assembly of the hoist apparatus 100, the winch 280 points outwards from the tripod 265 and is aligned with the pulley system 140.

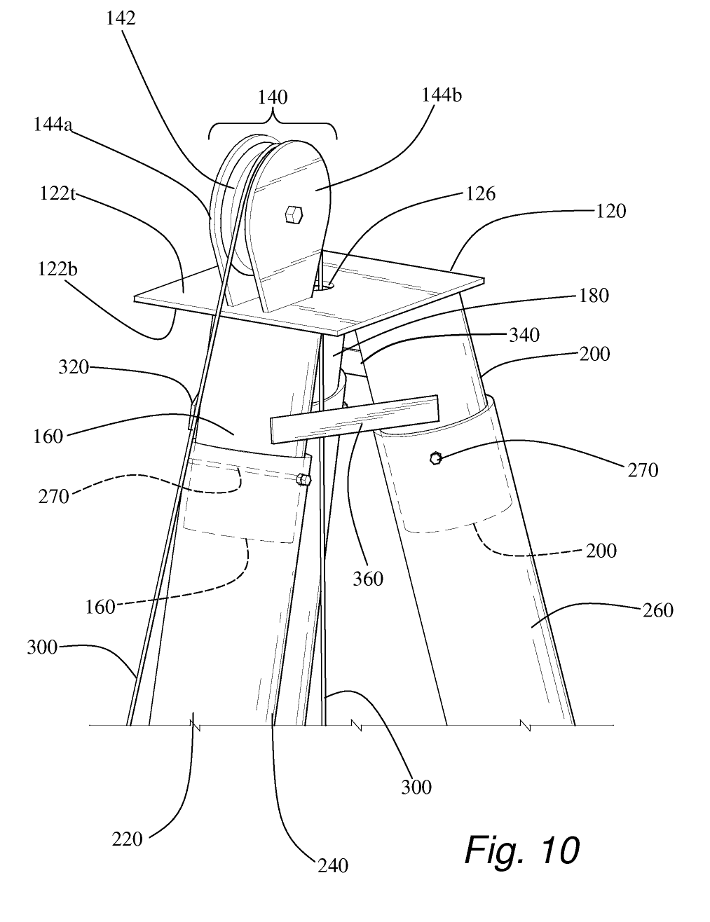

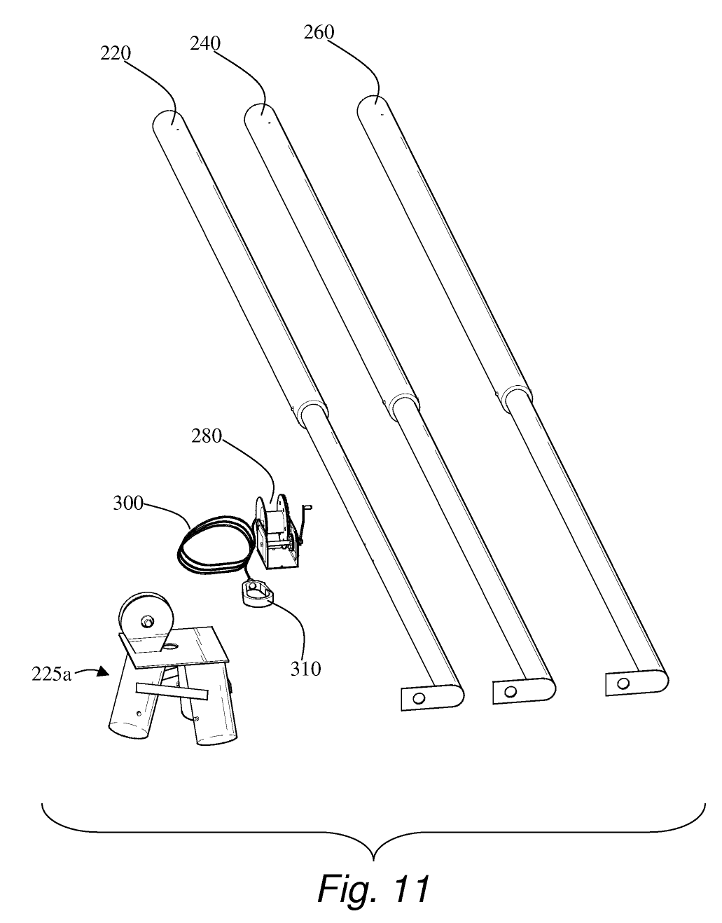

In one embodiment, each of the first, second and third legs 220, 240, and 260 have an open end and form a tripod when fitted over the open ends of the first, second and third legs 220, 240, and 260 are fitted over the first, second and third sleeves 180, 200 and 220 (see, e.g., FIG. 10). The first, second and third reinforcing bars 320, 340 and 360 can be repositioned to allow the legs to be fitted over the sleeves thereby providing a derivative single integral top section 225 (labeled as 225a in FIG. 11).

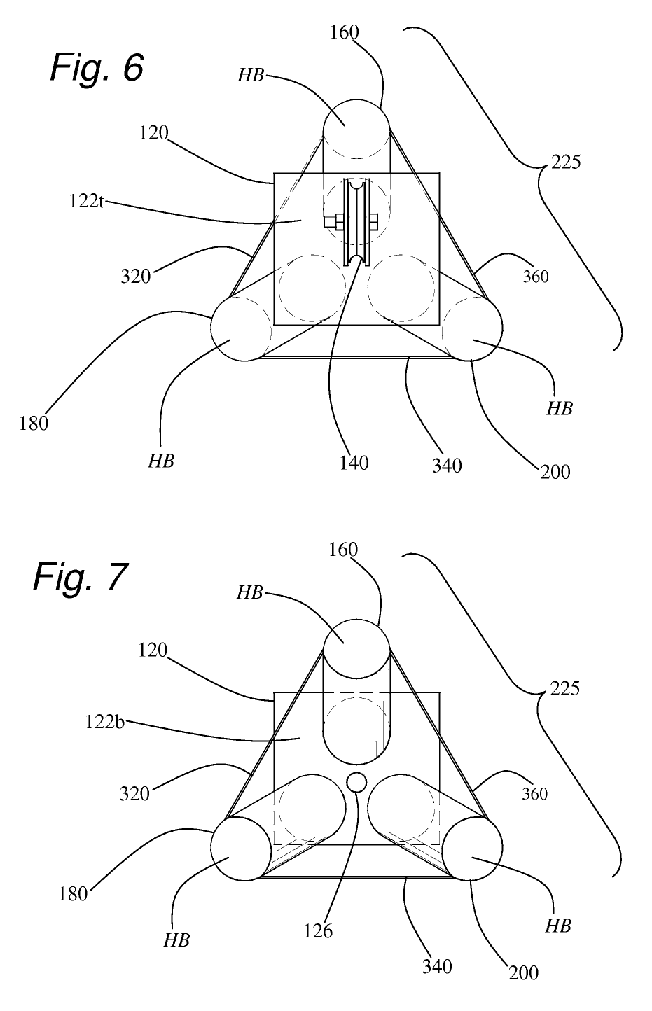

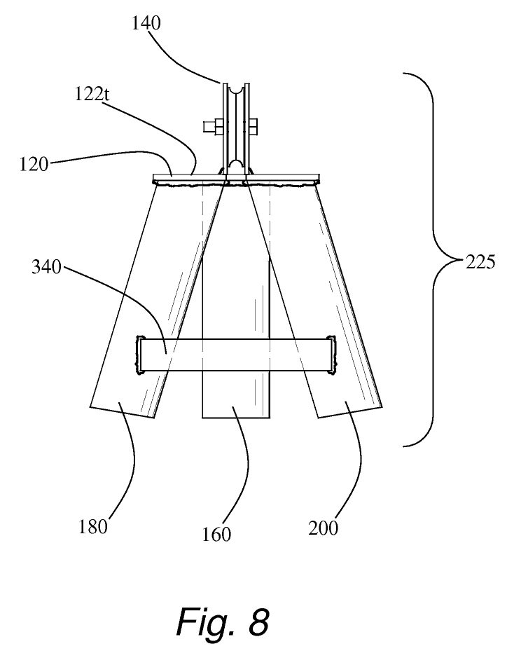

In one embodiment of the invention, the head plate 120, pulley system 140, and sleeves 180, 200 and 220 are integrated to provide a single integral top section 225 (see FIGS. 6 through 9), i.e., the top section comprises: the head plate 120, pulley system 140, and sleeves 180, 200 and 220.

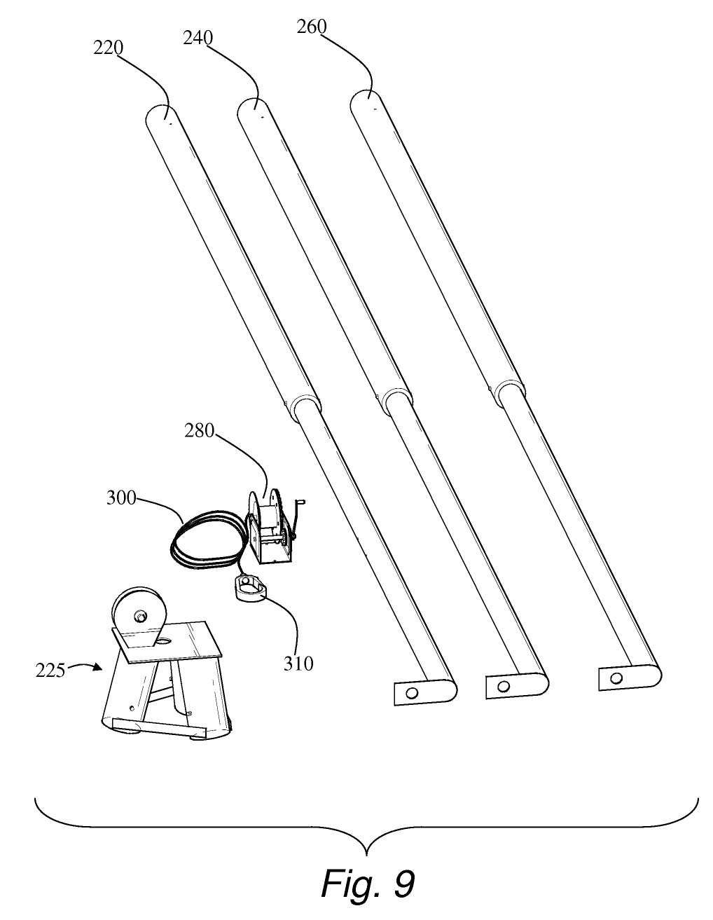

In another embodiment, the hoist apparatus 100 is provided in kit form (see FIG. 9) and includes: a top section 225; legs 220, 240, and 260; winch 280, and line 300.

All of the U.S. Patents cited in the present disclosure (including those U.S. Patents cited in the Background and Detailed Description sections) are incorporated by reference herein in their entirety. It is to be understood that the present invention is not limited to the embodiments described above, but encompasses any and all embodiments within the scope of the following claims.

I claim:

1. A hoist apparatus for hoisting items of interest to game hunters, comprising:
a head plate of generally planar appearance, said head plate defines a top surface, a bottom surface and a through-orifice;
a pulley system mounted on the top surface of said head plate and at a perpendicular angle with respect to said top surface;
a first sleeve, a second sleeve and a third sleeve, wherein each of said first, second and third sleeves have opposite ends with one end of each sleeve attached to the bottom surface of said head plate, wherein said first, second and third female sleeves each extend at a divergent angle away from the bottom surface of said head plate, wherein the other opposite end of each sleeve defines an open end, wherein one of the sleeves is aligned with said pulley system;
a plurality of legs, said plurality of legs comprising a first leg, a second leg and a third leg, wherein said first, second and third legs form a tripod when fitted into said first, second and third sleeves;
a winch, said winch is fitted to one of said legs such that upon assembly of said hoist apparatus said winch points outwards from said tripod and is aligned with said pulley system; and
a flexible line, said flexible line is controllably played out from said winch and extends from said winch to said pulley system and thence through said through-orifice in said head plate to dangle below said head plate and by means of said winch is used for hoisting a load, whereby the location of said pulley system atop of said head plate enhances safe operation wherein if said pulley system should fail then said head plate provides support for said flexible line thereby helping to prevent a load from falling to the ground.

2. The hoist apparatus of claim 1, wherein said pulley system comprises a free-wheeling pulley mounted between first and second pulley support members, wherein said first and second pulley support members are welded to the top surface of said head plate.

3. The hoist apparatus of claim 1, wherein said winch is a clutch type winch.

4. The hoist apparatus of claim 1, wherein said first, second and third legs are selectively height adjustable.

5. The hoist apparatus of claim 1 further comprising a first reinforcing bar, a second reinforcing bar, and a third reinforcing bar, wherein each of said first, second and third reinforcing bars respectively extend between said first and second sleeves, said second and third sleeves, and said third and first sleeves.

6. The hoist apparatus of claim 1, wherein said head plate, pulley system and said first, second and third sleeves are integrated to provide a tripod top section.

7. The hoist apparatus of claim 1, wherein said head plate, pulley system and said first, second and third sleeves are integrated to provide a tripod top section, and wherein said hoist apparatus is provided in kit form and includes: said top section, said first, second and third legs, said winch, and said line.

8. The hoist apparatus of claim 1, wherein said first, second and third legs are telescopic legs thereby allowing a user to set or adjust the height of said hoist apparatus.

9. A hoist apparatus for hoisting items of interest to game hunters, comprising:
a head plate of generally planar appearance, said head plate defines a top surface, a bottom surface and a through-orifice;
a pulley system mounted on the top surface of said head plate and at a perpendicular angle with respect to said top surface;
a first sleeve, a second sleeve and a third sleeve, wherein each of said first, second and third sleeves have opposite ends with one end of each sleeve attached to the bottom surface of said head plate, wherein said first, second and third female sleeves each extend at a divergent angle away from the bottom surface of said head plate, wherein one of the sleeves is aligned with said pulley system;
a first leg, a second leg and a third leg, wherein each of said first, second and third legs has an open end sized to accommodate at least one of said first, second and third sleeves, wherein said first, second and third legs form a tripod when fitted over said first, second and third sleeves;
a winch, said winch is fitted to one of said legs such that upon assembly of said hoist apparatus said winch points outwards from said tripod and is aligned with said pulley system; and
a flexible line, said flexible line is controllably played out from said winch and extends from said winch to said pulley system and thence through said through-orifice in said head plate to dangle below said head plate and by means of said winch is used for hoisting a load, whereby the location of said pulley system atop of said head plate enhances safe operation wherein if said pulley system should fail then said head plate provides support for said flexible line thereby helping to prevent a load from falling to the ground.

10. The hoist apparatus of claim 9, wherein said first, second and third legs are telescopic legs thereby allowing a user to set or adjust the height of said hoist apparatus.

11. A single integral top section, comprising:
a head plate of generally planar appearance, said head plate defines a top surface, a bottom surface and a through-orifice;
a pulley system mounted on the top surface of said head plate and at a perpendicular angle with respect to said top surface; and
a first sleeve, a second sleeve and a third sleeve, wherein each of said first, second and third sleeves have opposite ends with one end of each sleeve attached to the bottom surface of said head plate, wherein said first, second and third female sleeves each extend at a divergent angle away from the bottom surface of said head plate, wherein one of the sleeves is aligned with said pulley system.
